(19) United States
(12) Patent Application Publication
(10) Pub. No.: US 2014/0013920 A1
(43) Pub. Date: Jan. 16, 2014

(54) Apparatus for Grooving Cardboard Cuttings

(71) Applicant: Kolbus GmbH & Co. KG, Rahden (DE)

(72) Inventors: Klaus Gerke, Bassum (DE); Gerhard Lintelmann, Rahden (DE); Leonid Ugorets, Rahden (DE)

(21) Appl. No.: 13/940,427

(22) Filed: Jul. 12, 2013

(30) Foreign Application Priority Data
Jul. 12, 2012 (DE) 10 2012 013 805.9

(51) Int. Cl. B26D 3/06

(52) U.S. Cl. CPC B26D 3/065
USPC 83/875

(57) ABSTRACT

An apparatus (1) for grooving cardboard cuttings (2, 3) features a transport drum (11), spaced-apart belts (51) that revolve around rollers (54.1 to 54.8) such that an infeed (14) and an outlet (15) are formed. Groove cutting tools 72 are arranged between the belts (51) at a defined distance from the drum surface. The belts (51) and/or the groove cutting tools (72, 72.1 to 72.6) are situated on a first or second carrier (31) that can be displaced back and forth between a working position and an idle position radially to the transport drum (11). Another embodiment features several third carriers (52.1 to 52.7) that can be separately displaced relative to one another and to the transport drum (11) and feature at least the rollers (54.1 54.8) intended for guiding and tensioning a preferably individual belt (51).

### BACKGROUND

The present invention pertains to an apparatus for grooving cardboard cuttings.

Book cases, as well as boxes for high-quality sales and gift packages, are made from cardboards that are lined with cloth materials. In order to prepare bending points or sharp-edged bends, the cardboard cuttings are grooved at the corresponding locations. The groove cross section may have any profile from triangular to rectangular that is cut out of the cardboards in the form of waste with knife blades that are accordingly aligned relative to one another or circular knives and, if applicable, an intermediately arranged lift-out device or with one-piece special knives that are shaped in accordance with the respective cross section.

A known type of cardboard grooving machine comprises a horizontal transport drum driven about a drum axis, and a plurality of end effectors for processing cardboard cuttings on the transport drum. These end effectors can include a plurality of spaced-apart endless belts that are partially wrapped around the transport drum such that an infeed and an outlet are formed and the cardboard cuttings are pressed against and conveyed on the drum; rollers supporting each belt for revolving around the transport drum; and groove cutting tools that are arranged between the belts at a distance from the drum surface.

CN 101200091 B discloses a corresponding cardboard grooving machine, in which the belts that are partially wrapped around the transport drum are respectively guided by means of a guide roller and several deflection rollers and tensioned by separate pressure rollers. The guide rollers equipped with lateral flanged wheels are situated on a common shaft that is rotatably supported in the frame analogous to the deflection rollers and hold the belts driven by the transport drum in certain axial positions relative to the transport drum that are defined by the cardboard format and the length of the grooves to be cut.

During a set-up process, the belts therefore usually also need to be displaced into different positions. However, this is very labor-intensive because the assigned tension roller initially needs to be disengaged for each belt to be displaced in order to subsequently loosen and displace the respective guide rollers on the shaft into the target position incrementally and alternately with the groove cutting tools, wherein the transport drum in the meantime needs to be turned again and again such that the belts are not excessively interlaced. The belts ultimately need to be tensioned again by means of the tension rollers. The drum may also be damaged by the cutting knives that are arranged a short distance from the drum surface during the displacement of the groove cutting tools. This also applies to the removal or the exchange of the groove cutting tools.

### SUMMARY

The object of the invention is to provide a grooving apparatus that can be quickly and easily set up for different cardboard formats or changing groove positions.

This object is accomplished by situating at least some of the end effectors on a carrier that is selectively displaceable radially to the transport drum axis.

One or more displaceable carriers can be provided for a plurality of belts, a plurality of cutting tools and/or sets or subsets of rollers.

Preferably, a plurality of carriers with respective end effectors are individually displaceable radially to the transport drum axis and relative to each other, and individually displaceable axially relative to each other.

Further according to the disclosure, the belts are situated on a first carrier that can be displaced radially to the transport drum. The first carrier can be displaced back and forth between a working position and an idle position, in which it is radially moved away from the transport drum. In the working position, the belts held in their respective position are tensioned while they are at least relaxed and only lie loosely on the transport drum in the idle position such that the respective guide and tension rollers can be effortlessly displaced into different positions. All belts are tensioned simultaneously with the movement of the first carrier back into the working position such that the grooving apparatus is immediately ready for use.

The groove cutting tools can be arranged on a second carrier that can be displaced radially to the transport drum. In the idle position of the second carrier, in which it is radially moved away from the transport drum, all groove cutting tools are moved away from the drum surface and disengaged. They can be easily removed, exchanged or displaced into different positions. All groove cutting tools are once again ready for use once the second carrier has been moved back into the working position. It is also possible to jointly adjust the cutting depth of the groove cutting tools by changing the radial location of the second carrier in its working position. If the groove cutting tools are in the idle position moved away from the drum surface farther than the space occupied by the belts, the belts and the groove cutting tools can be axially displaced independently of one another—because they no longer mutually overlap in this case. Their respective sequence or arrangement relative to one another, in particular, can be changed without having to remove and reinstall individual groove cutting tools adjacent to other belts. It is therefore possible to axially adjust the groove cutting tools and/or the belts by means of motor-driven adjusting axles.

Several third carriers separately displaced relative to one another and to the transport drum and feature at least the rollers intended for guiding and for tensioning a preferably individual belt, can be provided. The guide and tension rollers of the respective belt are jointly displaced due to the third carriers that are displaceable relative to the transport drum. Their position relative to one another remains unchanged with respect to an aligned belt run and the belt elongation such that the time-consuming axial adjustment of the guide and tension rollers relative to one another is eliminated. The third carrier may be displaceable radially and/or axially to the transport drum.

In a preferred enhancement, the third carriers are arranged on the first carrier such that they can be displaced axially to the transport drum. The joint radial displacement of the belts is carried out by the first carrier in this case. The third carriers preferably can be fixed on the first carrier with the aid of clamping means. Clamping means can be quickly released and activated and respectively allow an infinitely variable or incremental positioning of the third carriers or the belts.

In an enhancement, all rollers for guiding, deflecting and tensioning the preferably individual belt are arranged on the respective third carrier. The deflection rollers extending from frame wall to frame wall are eliminated and a respective third carrier can be removed from the grooving apparatus as a whole for maintenance purposes such as, e.g., the exchange of the belt.

According to an enhancement, the third carriers respectively feature a carrying arm that lies to one side of the preferably individual belt and on which the rollers are arranged in the form of a cantilever support. In this way, worn out or damaged belts can be very easily exchanged without having to remove numerous components first.

In an enhancement, respective first and second rollers are arranged on the third carriers a certain distance in front of the infeed and/or outlet such that the belts respectively have a segment that tangentially extends toward the transport drum and a segment that tangentially extends away from the transport drum. In this way, an undesirable flexing and bending effect respectively can be significantly reduced in the infeed and in the outlet and the cardboards are delivered in a nearly planar fashion.

In an enhancement, third and fourth rollers are arranged on the third carriers in such a way that the segment between these rollers moves past the belt section adjoining the transport drum at a distance of less than 10 mm, preferably less than 5 mm. In this region of closest approach, the groove cutting tools can overlap the adjacent belt and the actual grooving knives can be positioned very close to the belt without the belts obstructing the discharge of accumulating waste.

In an enhancement, the belts are separately tensioned in a force-dependent or path-dependent fashion, wherein the roller intended for tensioning is situated on a tensioning lever that is movably arranged on the third carrier and acted upon by a force or wherein the respective roller can be displaceably fixed on the third carrier. In this way, an identical belt tension can be adjusted for each individual belt in dependence on its length that is subject to tolerances.

In an enhancement, the first and/or second carrier can be displaced with respect to their position relative to the transport drum with the aid of actuating means. The actuating means can be activated manually or in a motor-driven fashion. It may consist of a spindle-nut drive or comprise an actuating cylinder. The actuating means make it possible to position the first and/or second carrier in the working position, the idle position and, if applicable, any intermediate positions. The actuating means allow, in particular, variable working positions of the first and/or second carrier.

In an enhancement, the first and/or second carrier can be fixed in their working position relative to the transport drum with the aid of adjustable locking means. In this way, the respective working position can be quickly and reliably reached. Due to the locking effect, the working position also does not change under the load of the groove cutting process and/or the belt tension. The adjustability of the locking means makes it possible to carry out basic adjustments.

In an enhancement, at least one scale is provided on the first and/or second carrier in order to quickly and reproducibly position the groove cutting tools and/or the third carrier axially to the transport drum.

In a preferred enhancement, the second carrier is identical to the first carrier such that the belts, as well as the groove cutting tools, are situated on the same first carrier that can be displaced radially to the transport drum. The displacement of the first carrier into the idle position releases the belts and simultaneously the groove cutting tools for the axial position adjustment. They are simultaneously moved into their working positions once the common first carrier has been displaced back.

### BRIEF DESCRIPTION OF THE DRAWING

Characteristics of the present invention are described in greater detail below with reference to a preferred embodiment of the invention that is illustrated in the figures listed below. In these figures,

FIG. 1 shows a schematic side view of a grooving apparatus;

FIG. 2 shows a perspective representation of the grooving apparatus in the form of an oblique rear view;

FIG. 3 shows a first carrier of the grooving apparatus that is equipped with cutting tools and belts;

FIG. 4 shows a second carrier designed for guiding a belt, and

FIG. 5 shows a groove cutting tool equipped with a grooving knife.

### DETAILED DESCRIPTION

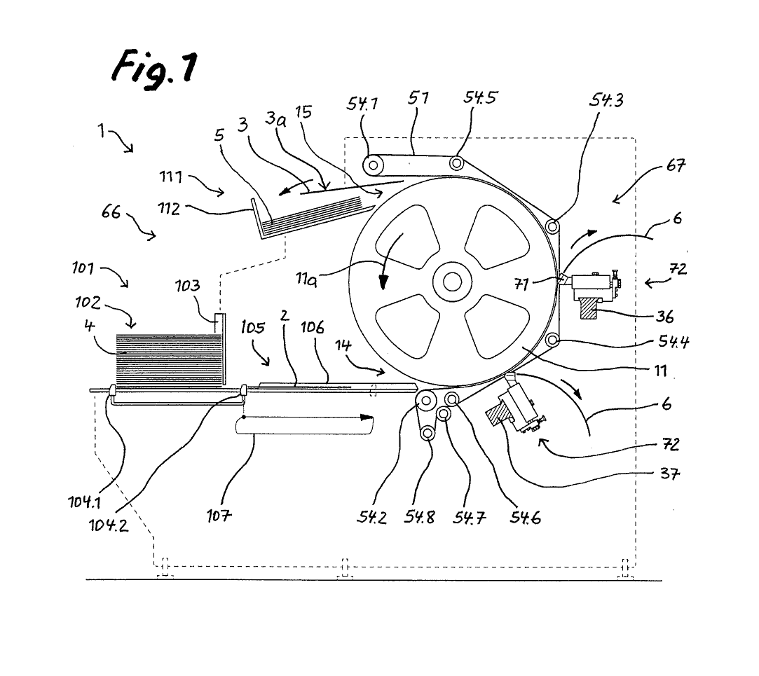

The grooving apparatus 1 schematically illustrated in FIG. 1 essentially consists of a driven, horizontally supported transport drum 11 and several spaced-apart endless belts 51 that revolve around rollers 54.1 to 54.8 and are partially wrapped around the transport drum 11 such that an infeed 14 and an outlet 15 are formed, as well as groove cutting tools 72 that are arranged between the belts 51 at a defined distance from the drum surface. Cardboard cuttings 2 transported to the infeed 14 by a feed device 101 are pressed onto the drum surface in an effectively conveying fashion by the belts 51 and transported from the infeed 14 situated at the lower vertex of the transport drum 11 to the outlet 15 situated at the upper vertex in the transport direction 11a during an approximately 180° rotation of the transport drum 11, wherein the cardboard cuttings are during this process guided past groove cutting tools 72, at which, for example, a V-shaped waste section 6 is cut out of the cardboard cuttings 2 with correspondingly shaped grooving knives 71.

The feed device 101 in FIG. 1 features a cardboard magazine 102 that can be filled in an ergonomically advantageous fashion and contains a stack 4 of cardboard cuttings that lie on top of one another. The respective bottom cardboard cutting 2 is ejected underneath a front stop 103 by a first cardboard pusher 104.1 and transferred into an intermediate position, from which the cardboard cutting 2 is transported to the infeed 14 by a second cardboard pusher 104.2 while being aligned on outer guide rails 106. The cardboard pushers 104.1, 104.2 are coupled at a fixed distance from one another and cyclically moved forward and backward with a constant transport stroke 107 that corresponds to this fixed distance. In this case, the transport speed is slightly higher than the rotational speed of the transport drum 11 such that the cardboard cuttings 2 effectively are forcibly pushed into the infeed 14 between transport drum 11 and belt 51.

Since the rollers 54.2 are arranged a certain distance in front of the infeed 14, the belts 51 have a segment that tangentially extends toward the transport drum 11. In this way, flexing and bending are significantly reduced in the infeed 14. In addition, the segment supports the alignment of the cardboard cuttings 2 on the slightly faster moving cardboard pushers 104.2 of the feed device 101.

The delivery 111 in FIG. 1 features a delivery table 112 that slopes obliquely forward, wherein the completely grooved cardboard cuttings 3 exiting the outlet 15 are dropped onto said delivery table and placed on top of one another in order to form a stack 5. Since the outlet 15 is arranged at the upper vertex of the transport drum 11, the cut grooves 3 lie on the upper side of the exiting cardboard cuttings 3. Consequently, the cut grooves 3a are visible from above during the operation of the apparatus and the groove quality can be continuously assessed on any of the cardboards being delivered without having to remove individual cardboard cuttings 3. The delivery of the grooved cardboard cuttings 3 at the upper vertex of a transport drum 11 and the depositing on the delivery table 112 arranged at a lower height furthermore result in an ergonomically advantageous removal height.

Since the rollers 54.1 are arranged a certain distance in front of the outlet 15, the belts 51 have a segment that tangentially extends away from the transport drum 11. In this way, flexing and bending are significantly reduced in the outlet 15 and the grooved cardboard cuttings 3 are delivered in a nearly planar fashion.

The delivery 111 and the feed device 101 lie on the same side of the transport drum 11, namely the so-called operating site 66, while the groove cutting tools 72 are situated on the opposite tool side 67 and freely accessible.

According to FIG. 1, the rollers 54.1 to 54.8 are arranged around the transport drum 11 in such a way that a total of three areas of closest approach between the segments that lie between the rollers 54.5 and 54.3, 54.3 and 54.4, 54.4 and 54.6 and the belt sections adjoining the transport drum 11 are formed in the exemplary embodiments. The groove cutting tools 72 and, if applicable, additional processing means such as, e.g., a gluing device may be arranged in these areas. The groove cutting tools 72 are mounted on supporting beams 36, 37 that lie parallel to the transport drum 11. Several groove cutting tools 72 may be mounted adjacent to one another. Grooves 3a that lie very close to one another can be produced due to the arrangement on two supporting beams 36, 37 that lie behind one another in the transport direction 11a.

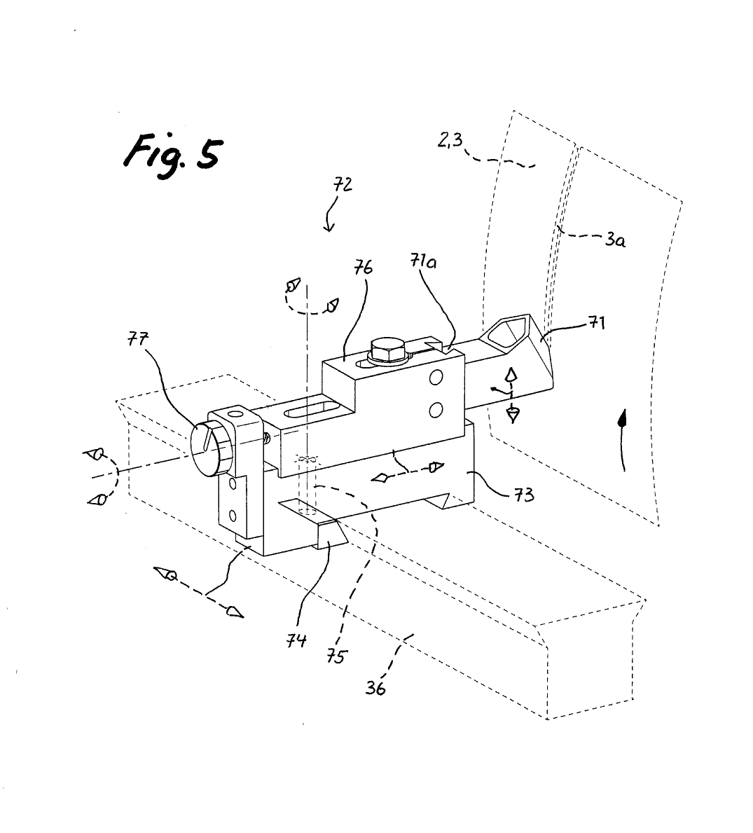

FIG. 5 shows an example of a groove cutting tool 72. It includes a carrier 73 that can be fixed on the supporting beam 36 with a clamping block 74 that is actuated by means of a clamping screw 75. A receptacle slide 76 for the grooving knife 71 provided with a dovetail guide 71a is mounted on the carrier 73. After loosening the clamping block 74, the groove cutting tool 72 can be displaced axially referred to the transport drum 11 such that the position of the groove 3a to be cut in the cardboard cutting 3 can be changed. In addition, the receptacle slide 76 can be released and displaced in small increments radially referred to the transport drum 11 by means of a dial 77 such that the respective cutting depth can be adjusted. The grooving knife 71 ultimately can also be adjusted transverse to the two aforementioned adjusting directions by means of its dovetail guide 71a.

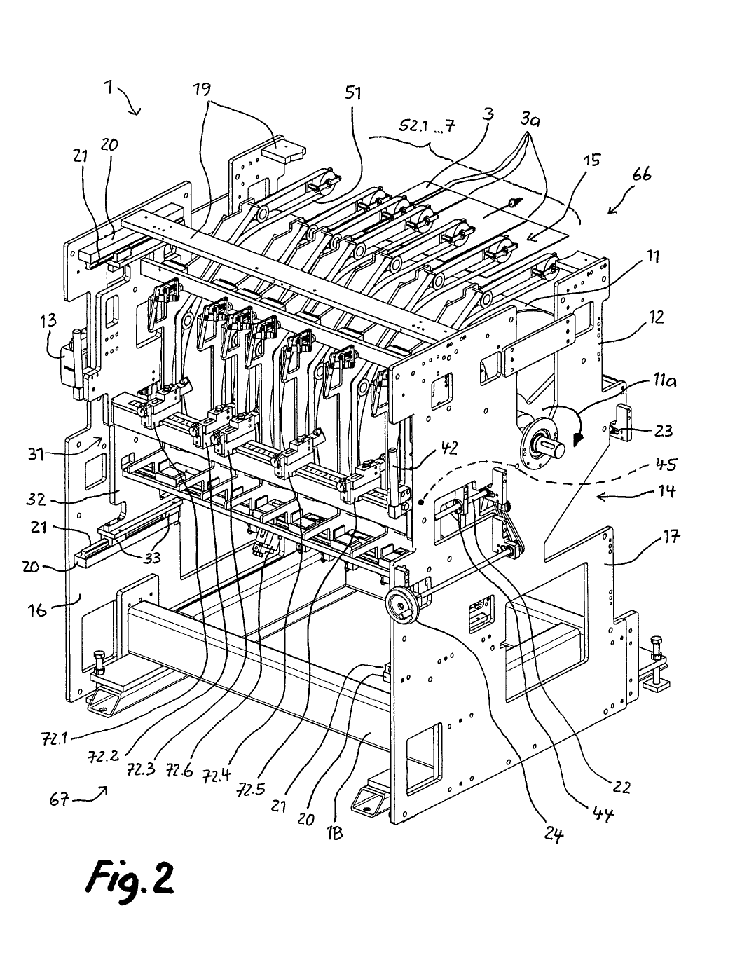

FIG. 2 shows the constructive design of the grooving apparatus 1. The transport drum 11 is driven by a geared motor 13 and rotatably supported in a frame 12 that includes a pedestal 18, two sidewalls 16, 17 and several plates 19 that mutually support and connect the lateral parts.

A carrier 31 that embodies the first and the second carrier is guided in the frame 12 such that it can be displaced radially to the transport drum 11, wherein the different groove cutting tools 72.1 to 72.6 and the belts 51 are situated on this carrier. The carrier 31 is henceforth referred to as first carrier 31 and features a frame 32 that is guided on guide rails 21 situated on plates 20 mounted on the sidewalls 16, 17 by means of linear guides 33. The position of the first carrier 31 relative to the transport drum 11 is adjusted with adjusting spindles 22 that are supported in the sidewalls 16, 17 and engage into adjusting nuts 44 accommodated on the outside of the frame 32. The two adjusting spindles 22 are coupled to one another by means of a drive connection 23 and actuated with a handwheel 24 in the exemplary embodiment. The first carrier 31 may alternatively also be displaced by pneumatic cylinders or similar actuating means.

The first carrier 31 with the groove cutting tools 72.1 to 72.6 and the belts 51 is essentially displaced between a working position and an idle position. In the working position, the belts 51 held in their respective position are tensioned while they are at least relaxed and only lie loosely on the transport drum 11 in the idle position such that the belts 51 can be effortlessly displaced into different positions. The belts 51 are situated on third carriers 52.1 to 52.7 that are arranged on the first carrier 31 such that they can be displaced axially to the transport drum 11 and separately displaced relative to one another. All belts 51 are tensioned simultaneously with the movement of the first carrier 31 back into the working position such that the grooving apparatus 1 is immediately ready for use. The working position is reached and secured when locking levers 41 arranged to both sides of the first carrier 31 engage on locking bolts 45 that are adjustably mounted on the frame 12. The locking levers 41 can be opened again with the aid of actuating levers 42.

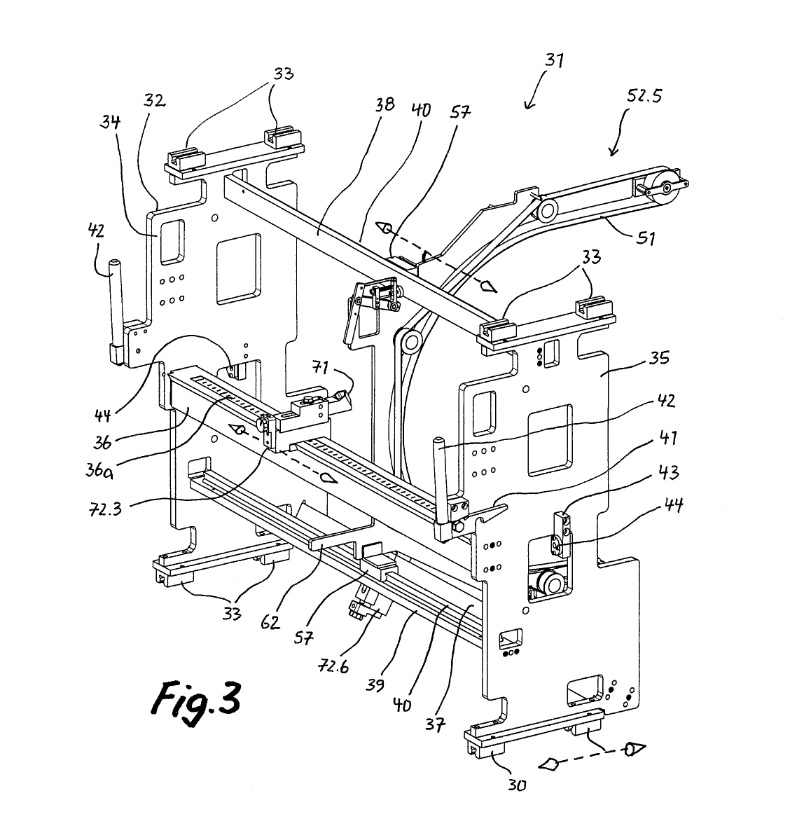

FIG. 3 shows the first carrier 31 in greater detail. Its frame 32 is composed of a left and a right sidewall 34, 35 that are connected to one another by means of plates 38, 39, as well as the aforementioned supporting beams 36, 37. The linear guides 33 are situated on the upper and lower faces of the sidewalls 34, 35 while the adjusting nuts 34 are accommodated in holders 43 arranged on the respective outer wall. Only a single third carrier 52.5 and one respective groove cutting tool 72.3, 72.6 on the two supporting beams 37, 38 are illustrated in FIG. 3 in order to provide a better overview.

The groove cutting tools 72.1 to 72.6 can be exchanged or adjusted in the idle position of the first carrier 31, in which it is moved away from the transport drum 11. A scale 36a recessed into the respective supporting beams 36, 37 serves for the exact axial positioning. Guide rails 40 mounted on the plates 38, 39 are provided for accommodating the third carriers 52.1 to 52.7 that are respectively equipped with one individual belt 51 in a displaceable fashion, wherein linear guides 57 arranged on the third carriers 52.1 to 52.7 run on said guide rails.

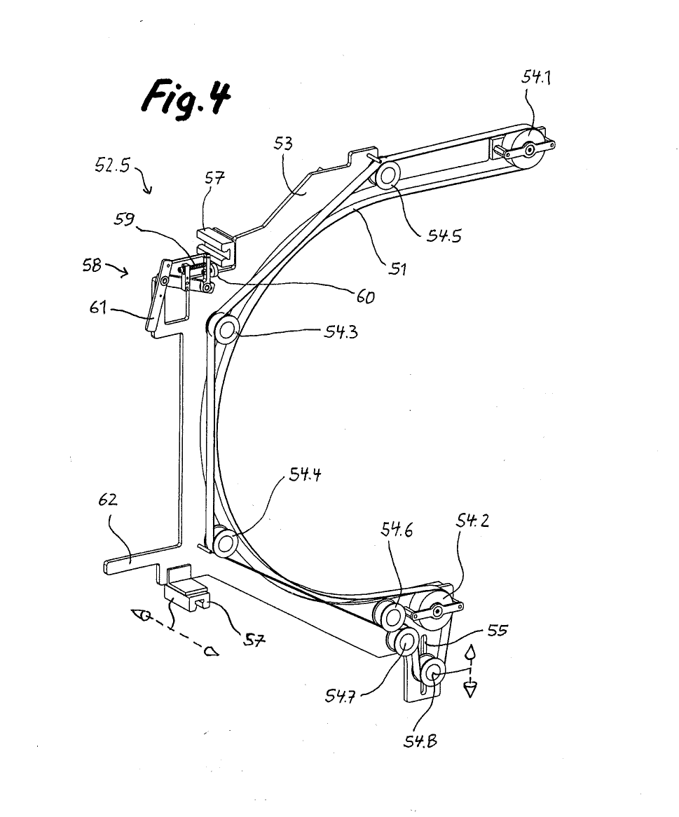

FIG. 4 shows one individual third carrier 52.5 in greater detail. It includes a carrying arm 53 with the rollers 54.1 to 54.8 that deflect and axially guide the belt 51 arranged thereon in the form of a cantilever support. The first roller 54.1 and the second roller 54.2 are respectively arranged a certain distance in front of the outlet 15 and the infeed 14. The rollers 54.3 to 54.6 are provided as third and fourth rollers in the three pairs 54.3 and 54.4, 54.3 and 54.5, 54.4 and 54.6 that respectively form segments passing near the transport drum 11. The roller 54.8 can be fixed in an oblong hole 55 of the carrying arm 53 in the form of a tension roller in order to realize a path-dependent elongation of the respective belt 51 such that each individual belt 51 of the grooving apparatus 1 can be individually tensioned. Due to the cantilever support of the rollers 54.1 to 54.8, the groove cutting tools 72.1 to 72.6 can be positioned very close to the belts 51. A possibly required belt change can also be carried out in a very simple fashion.

The carriers 52.1 to 52.7 feature a clamping device 58 with a pressure pad 60 that is subjected to a force by a pressure spring 59 and engages on the plate 38 of the first carrier 31. In the idle position of the first carrier 31, in which it is moved away from the transport drum 11, one respective third carrier 52.1 to 52.7 can be displaced into a new axial position by means of a sliding handle 62 after the pressure pad 60 has been loosened by means of an actuating lever 61, wherein the scale 36a can be used in order to locate the new axial position faster.

The described exemplary embodiment combines the characteristics of the three independently employable features:
1) belts on a first carrier 31 that can be displaced radially to the transport drum 11;
2) groove cutting tools 72.1 to 72.6 on a second carrier 31 that can be displaced radially to the transport drum 11 and is identical to the first carrier 31 in the exemplary embodiment;
3) several third carriers 52.1 to 52.7 that can be separately displaced relative to one another and to the transport drum 11 and feature at least the rollers 54.1 to 54.8 intended for guiding and for tensioning a preferably individual belt 51, wherein these third carriers are in the exemplary embodiment situated on the first carrier 31 such that they can be axially displaced.

In general, a belt, a cutting tool, a set or subset of rollers, or other component that may be involved in processing the cardboard cuttings on the transport drum, can be considered as an end-effector supported by a carrier that is radially displaceable relative to the transport drum. At least one carrier for the belts and/or at least one carrier for the cutting tools can be combined as a single common carrier, distinct carriers, or distinct carriers on a common carrier.

Alternative exemplary embodiments may be respectively based on the characteristics of only one individual independent feature or reflect a respective combination of the characteristics of two independent features.

In this respect, one particular alternative embodiment of the third carriers 52.1 to 52.7 is described below. Instead of arranging all rollers 54.1 to 54.8 on the carrying arm 53 of the respective carrier 52.1 to 52.7, it would also be possible to only arrange one roller provided for axially guiding the belt 51 such as, e.g., the roller 54.1 and the tensioning roller, namely the roller 54.8, on the carrying arm 53 while the remaining rollers are replaced with deflection rollers supported in the first carrier 31. In this embodiment, the set-up time already is significantly reduced and the user-friendliness is simultaneously improved. The deflection rollers may alternatively also be supported in the frame 12. The individually tensioned belts 51 guided on the third carriers 52.1 to 52.7 can also be axially displaced in the tensioned state while the transport drum 11 rotates in that actuating drives engage on the third carriers 52.1 to 52.7 while the protective device is closed.

1. An apparatus for grooving cardboard cuttings (2, 3), comprising: a horizontal transport drum (11) driven about a drum axis; a plurality of end effectors (51, 54, 72) for processing cardboard cuttings on the transport drum including (i) a plurality of spaced-apart endless belts (51) that are partially wrapped around the transport drum (11) such that an infeed (14) and an outlet (15) are formed and the cardboard cuttings (2) are pressed against and conveyed on the drum; (ii) a respective set of rollers (54.1 to 54.8) supporting each belt for revolving around the transport drum; and (iii) a plurality of groove cutting tools (72, 72.1 to 72.6) that are arranged between the belts at a distance from the drum surface; wherein at least some of said plurality of end effectors are situated on a carrier (31, 52, 73) that is selectively displaceable radially to the transport drum axis.

2. The apparatus according to claim 1, wherein said at least some end effectors are said plurality of belts.

3. The apparatus according to claim 1, wherein said at least some end effectors are said plurality of cutting tools.

4. The apparatus according to claim 1, wherein said at least some end effectors are at least two rollers in each of a plurality of said sets of rollers.

5. The apparatus according to claim 1, wherein a set of said rollers is situated on each of said plurality of carriers.

6. The apparatus according to claim 1, wherein a plurality of carriers with respective end effectors are individually displaceable radially to the transport drum axis and relative to each other.

7. The apparatus according to claim 1, wherein a plurality of carriers with respective end effectors are individually displaceable axially relative to each other.

8. The apparatus according to claim 6, wherein said plurality of carriers are individually displaceable axially relative to each other.

9. The apparatus according to claim 1, wherein said plurality of belts are situated on a first said carrier that is selectively displaceable radially to the transport drum axis and said plurality of cutting tools are situated on a second said carrier that is selectively displaceable radially to the transport drum axis.

10. The apparatus according to claim 9, wherein said first and second carriers are integrated in a common carrier.

11. The apparatus according to claim 10, wherein the first and second carriers are independently adjustable axially.

12. The apparatus according to claim 1, wherein each of a plurality of carriers (52.1 to 52.7) supporting a respective plurality of rollers is separately displaceable laterally relative to one another.

13. The apparatus according to claim 1, wherein each of a plurality of carriers (52.1 to 52.7) supporting a respective plurality of rollers is separately displaceable laterally relative to one another and radially to the transport drum, for guiding and tensioning a respective plurality of individual belts.

14. The apparatus according to claim 1, wherein said plurality of belts are situated on a belt carrier and each of a plurality of other carriers supporting a respective set of rollers (52.1 to 52.7) is clamped to the belt carrier.

15. The apparatus according to claim 1, wherein each set of rollers (54.1 to 54.8) guides, deflects and tensions a belt and is arranged on a respective dedicated roller carrier (52.1 to 52.7); said plurality of belts are situated on a belt carrier that is selectively displaceable radially to the transport drum axis; and said dedicated roller carriers are supported on said belt carrier.

16. The apparatus according to claim 1, wherein each set of rollers (54.1 to 54.8) guides, deflects and tensions a belt and is arranged on a respective dedicated roller carrier (52.1 to 52.7); said plurality of cutting tools are situated on a tool carrier that is selectively displaceable radially to the transport drum axis; and said dedicated roller carriers are supported on said tool carrier.

17. The apparatus according to claim 15, wherein the dedicated roller carriers respectively feature a carrying arm (53) that lies to one side of a respective individual belt and on which the rollers are arranged in the form of a cantilever support.

18. The apparatus according to one of claim 16, wherein the dedicated roller carriers respectively feature a carrying arm (53) that lies to one side of a respective individual belt and on which the rollers are arranged in the form of a cantilever support.

19. The apparatus according to claim 1, wherein said at least some end effectors are said plurality of belts situated on a belt carrier and/or said plurality of cutting tools situated on a tool carrier; and respective first and second rollers (54.1, 54.2) are respectively arranged on additional, dedicated roller carriers (52.1 to 52.7) a certain distance in front of the infeed and/or outlet (14, 15) such that the belts respectively have a segment that tangentially extends toward the transport drum and a segment that tangentially extends away from the transport drum.

20. The apparatus according to claim 19, wherein third and fourth rollers (54.3, 54.4/54.3, 54.5/54.4, 54.6) are arranged on the respective dedicated roller carriers (52.1 to 52.7) such that a belt segment formed between these rollers passes a belt section adjoining the transport drum at a distance of less than 10 mm, preferably less than 5 mm.

21. The apparatus according to claim 19, wherein the belts are separately held in tension by a tension roller (54.8) situated on a tensioning lever that is movably arranged on the dedicated roller carrier (52.1 to 52.7).

22. The apparatus according to claim 19, including at least one axially extending scale (36a) on at least one of the belt carrier and tool carrier for axially positioning the groove cutting tools or the additional carrier relative to the transport drum.

23. The apparatus according to claim 1, wherein the tool carrier is identical to the belt carrier such that the groove cutting tools and the belts are situated on the same carrier that can be displaced radially to the transport drum.

24. The apparatus according to claim 1, wherein said plurality of belts are situated on a carrier that is selectively displaceable radially to the transport drum axis; said plurality of cutting tools are situated on a carrier that is selectively displaceable radially to the transport drum axis; and said sets of rollers are situated on at least one additional carrier that is selectively displaceable radially to the transport drum axis.
